(19) United States
(12) Patent Application Publication
(10) Pub. No.: US 2018/0026413 A1
(43) Pub. Date: Jan. 25, 2018

(54) PLUG MODULE SYSTEM

(71) Applicant: Molex, LLC, Lisle, IL (US)

(72) Inventors: Philip J. Dambach, Naperville, IL (US); Kent E. Regnier, Lombard, IL (US)

(73) Assignee: Molex, LLC, Lisle, IL (US)

(21) Appl. No.: 15/546,563

(22) PCT Filed: Jan. 27, 2016
(86) PCT No.: PCT/US16/15098

§ 371 Date: Jul. 26, 2017

Related U.S. Application Data
(60) Provisional application No. 62/108,276, filed on Jan. 27, 2015.

(51) Int. Cl. H01R 31/00; H01R 13/6461; H01R 24/60; H01R 13/627

(52) U.S. Cl. CPC H01R 31/005; H01R 13/6275; H01R 13/6461; H01R 24/60; H01R 2107/00

(57) ABSTRACT

A plug module is provided that includes a first mating end and a second mating end. The first mating end is configured to mate with a predefined port, such as a QSFP port. The second mating end can support two or more micro receptacles that allow the plug module to provide an octopus-like cable assembly without requiring the predetermination of a particular length of cable.

### RELATED APPLICATIONS

This application claims priority to U.S. Provisional Application No. 62/108,276, filed Jan. 27, 2015, which is incorporated herein by reference in its entirety.

### TECHNICAL FIELD

This disclosure relates to the field of input/output (IO) connectors, more specifically to IO connectors suitable for use in high data rate applications.

### DESCRIPTION OF RELATED ART

Input/output (IO) connectors that have four communication channels (e.g., 4 transmits and 4 receives) are known. One example is the quad small form-factor pluggable (QSFP) connector. These types of connectors are suited to support high bandwidth applications due to the inclusion of the four communication channels.

One issue that sometimes comes up with a connector such as the QSFP style connector is that there is a desire to have a large amount of bandwidth available on a switch that is positioned as a Top of Rack (ToR) switch but the bandwidth available in one QSFP port provided in such a ToR switch might be greater than another single port really needs. The desire to break out the channel sometimes existed in standard QSFP products that provided 40 Gbps and this desired is expected to become a more prevalent issue in products designed to support 100 Gbps, such as 100 Gbps capable QSFP products.

One existing way to address this issue is to have what is sometime referred to as a break-out cable or octopus cable. For example, a cable assembly could have a QSFP plug module on one end and have four cables extending from the QSFP plug to four separate small form-factor pluggable (SFP) style plug modules. This allows a single QSFP port to communicate with 4 SFP ports and, for high performing assemblies, each communication channel can support 25 Gbps of bidirectional communication. While this is an effective way to break out the four communication channels so as to allow one port to communicate with four other ports, the use of octopus cables is generally disfavored. One issue is that a cable from a ToR switch will have to reach lengths of less than a foot to more than a meter. As can be appreciated, it is difficult to know in advance how far each cable of an octopus cable assembly is going to need to reach. Therefore it is common to select a length that is long enough for all cases but is too long for most cases. This tends to result in a mess of cables that is difficult to understand or work with once installed. Consequentially, certain individuals would appreciate further improvements in connector configurations.

### SUMMARY

A plug module is disclosed that includes a first mating end that is configured to mate with a predefined port (such as a conventional connector receptacle) and has a second mating end that includes a plurality of micro receptacles. A paddle card can be positioned at the first mating end and the micro receptacles can be supported so that they are offset upward, compared to the paddle card. A plurality of cable assemblies with micro plugs can be connected to the plurality of micro receptacles such that each cable assembly can offer a different length and have a desired far end termination configuration.

### BRIEF DESCRIPTION OF THE DRAWINGS

The present invention is illustrated by way of example and not limited in the accompanying figures in which like reference numerals indicate similar elements and in which:

FIG. 1 illustrates a perspective view of an embodiment of a break out connector module.

FIG. 2 illustrates a simplified perspective view of the embodiment depicted in FIG. 1.

FIG. 3 illustrates a perspective, partially exploded view of the embodiment depicted in FIG. 2.

FIG. 4 illustrates an exploded perspective view of the embodiment depicted in FIG. 2.

FIG. 5 illustrates a perspective simplified view of the embodiment depicted in FIG. 4.

FIG. 6 illustrates a perspective enlarged view of the embodiment depicted in FIG. 5.

FIG. 7 illustrates a perspective simplified view of the embodiment depicted in FIG. 6.

FIG. 8 illustrates a perspective view of the embodiment depicted in FIG. 7.

FIG. 9 illustrates a perspective view of the embodiment depicted in FIG. 8 but with a latch in a second position.

FIG. 10 illustrates a perspective view of an embodiment of a break out module with the latch system removed.

FIG. 11 illustrates a perspective view of an embodiment of a circuit board supporting four connectors.

FIG. 12 illustrates a perspective simplified view of the embodiment depicted in FIG. 11 with just one connector housing positioned on the circuit board.

FIG. 13 illustrates another perspective view of the embodiment depicted in FIG. 12.

FIG. 14 illustrates a perspective view of an embodiment of a first housing wafer.

FIG. 15 illustrates another perspective view of the embodiment depicted in FIG. 14.

FIG. 16 illustrates a perspective view of an embodiment of a second housing wafer.

FIG. 17 illustrates another perspective view of the embodiment depicted in FIG. 16.

FIG. 18 illustrates a perspective, partially exploded view of an embodiment of a first housing wafer.

FIG. 19 illustrates another perspective view of the embodiment depicted in FIG. 18.

FIG. 20 illustrates another perspective view of the embodiment depicted in FIG. 18.

FIG. 21 illustrates an elevated rear view of a portion of an embodiment of a terminal set, showing an embodiment of uniform construction of the terminals.

FIG. 22 illustrates a perspective simplified view of an embodiment of a first housing wafer with a terminal block removed.

FIG. 23 illustrates a schematic representation of an embodiment of a cable assembly.

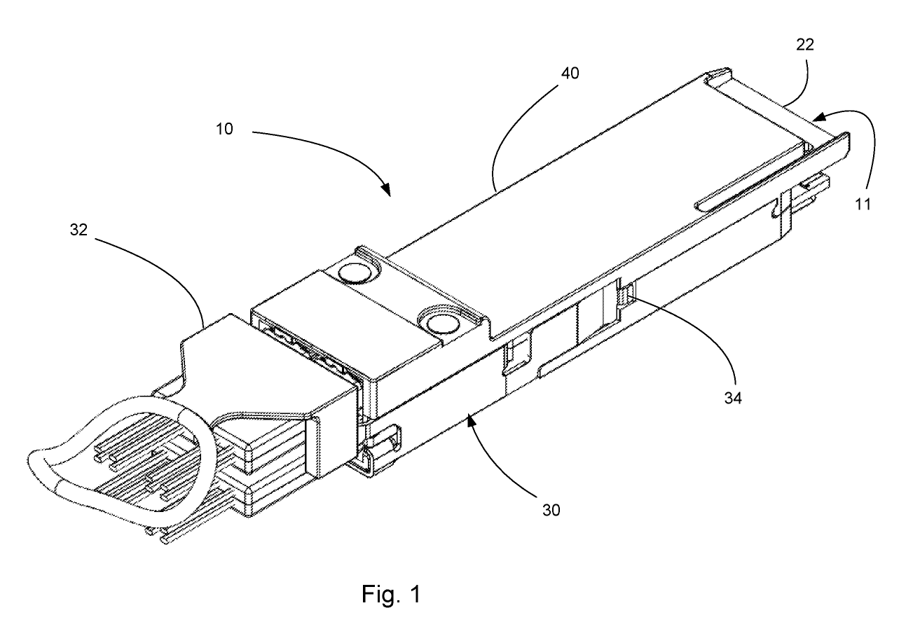

### DETAILED DESCRIPTION

The detailed description that follows describes exemplary embodiments and is not intended to be limited to the expressly disclosed combination(s), Therefore, unless otherwise noted, features disclosed herein may be combined together to form additional combinations that were not otherwise shown for purposes of brevity.

As can be appreciated from the Figures, a plug module 10 is depicted and as depicted can result in a quad small-form factor pluggable (QSFP) module. Thus, the depicted embodiment allows for the insertion of the plug module 10 into an existing QSFP receptacle port and can provide four break out connectors. QSFP modules are fairly beneficial for Top of Rack (ToR) applications as well as many other applications that benefit from 4 channels of high-speed data. The features discussed herein, however, are not limited to use with QSFP style connectors as other sized plug receptacle could also provide similar functionality (with larger plug modules potentially supporting additional connectors).

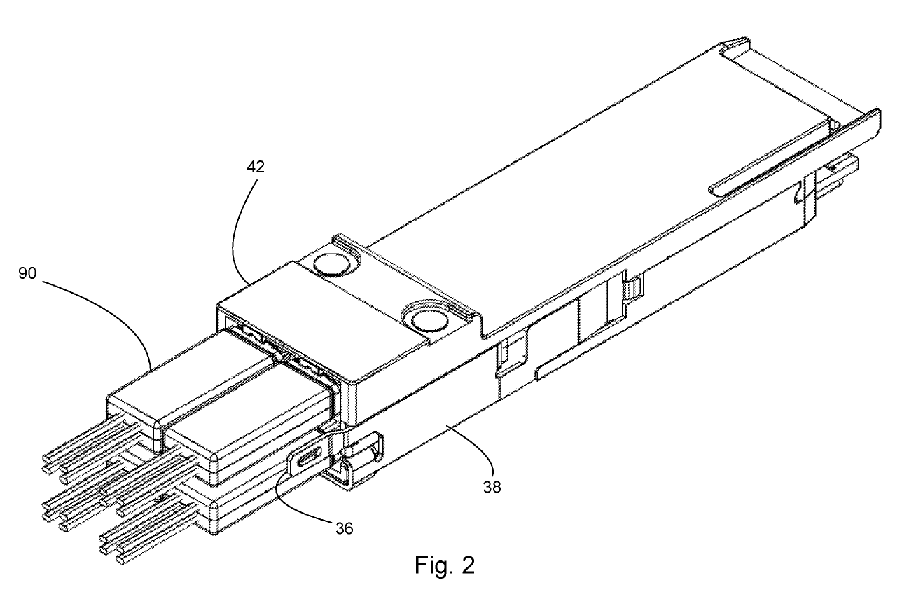

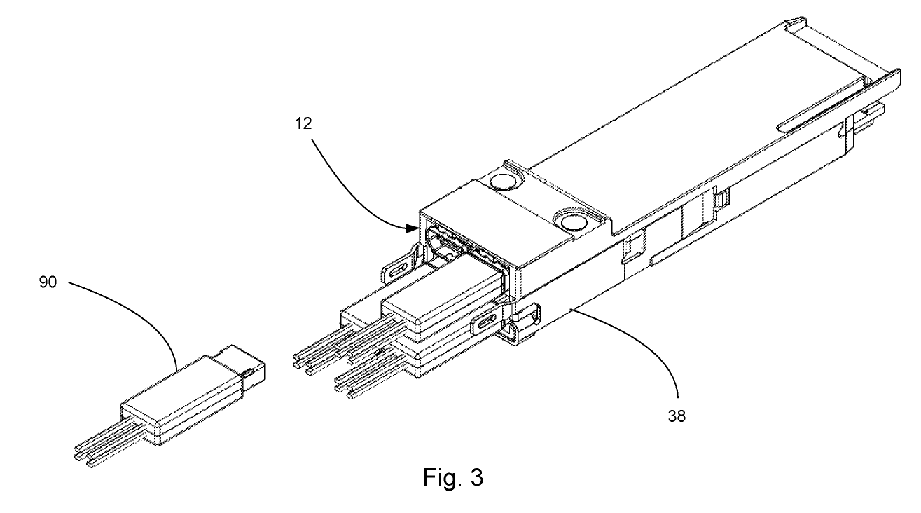

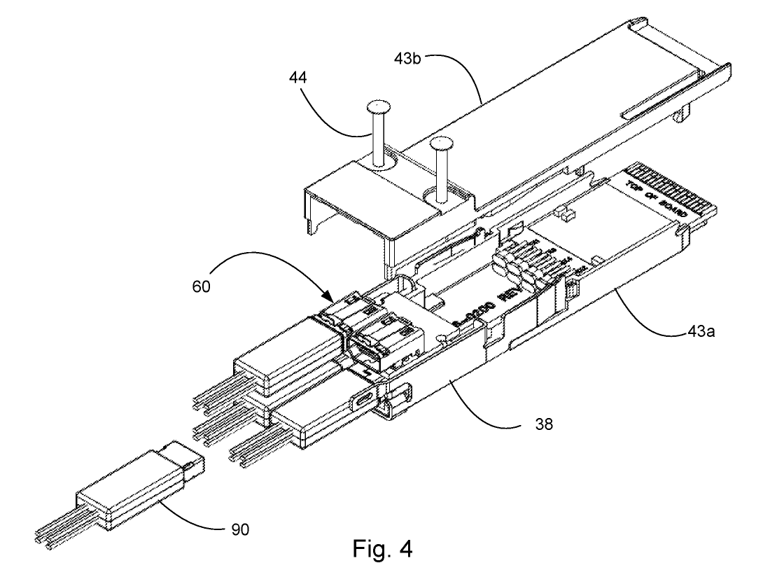

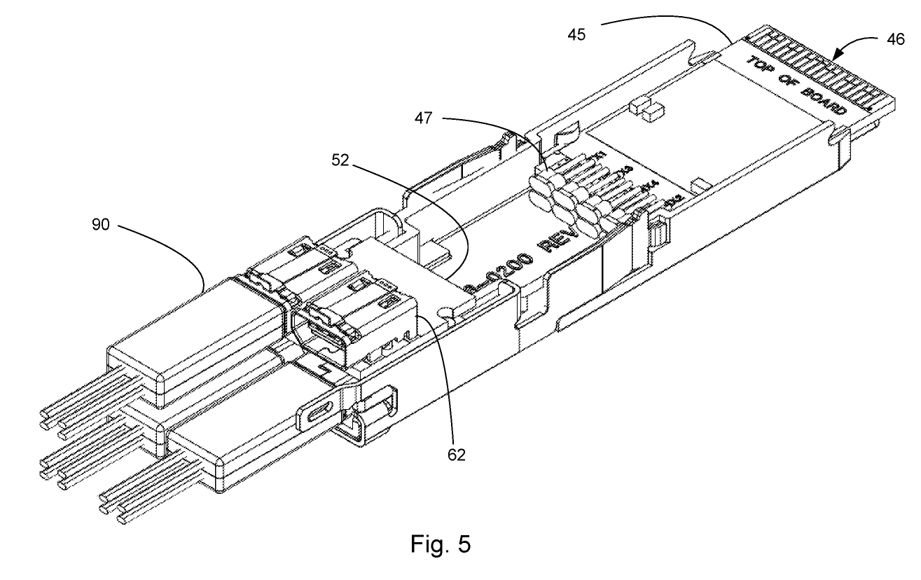

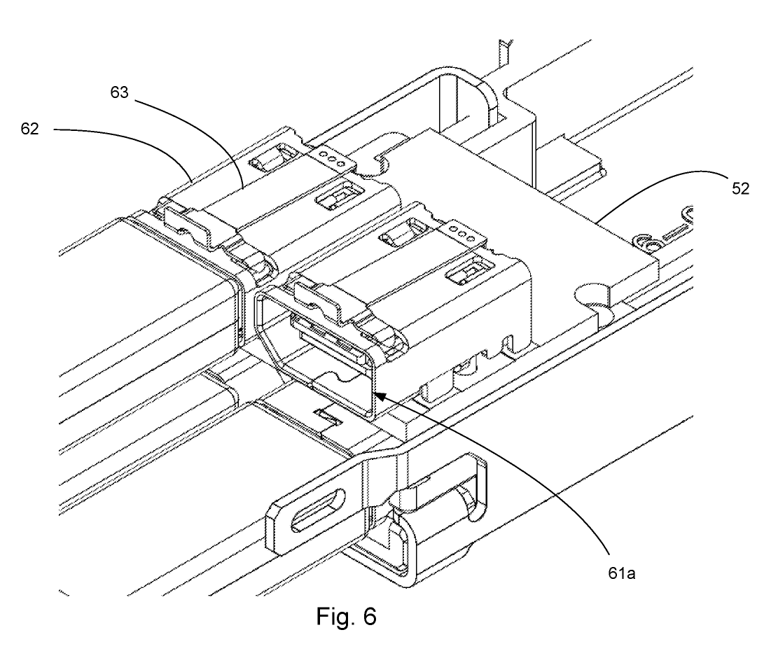

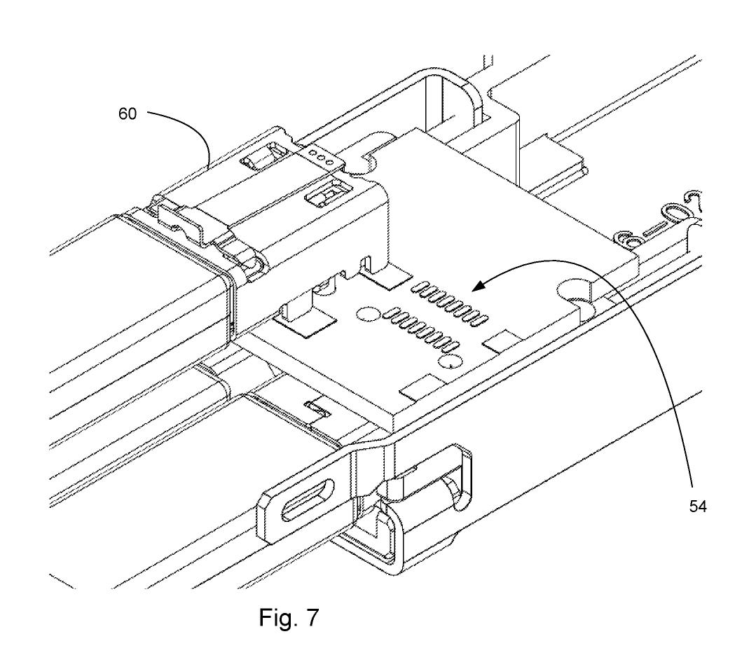

The depicted plug module 10 includes a latch 30 with an optional pull-tab 32 that is removed in FIG. 2. As can be appreciated, the plug module has a body 40 formed of a lower half 43a and an upper half 43b that are secured together with fasteners 44 and the plug module 10 has a first mating end 11 and a second mating end 12 opposing the first mating end 11. In operation, the first mating end 11 is configured to mate with a receptacle (not shown but which could be a standard QSFP receptacle) and the second mating end 12 is intended to provide receptacles as discussed herein.

A paddle card 45 with contact pads 46 is provided on a first mating end 11 and the paddle card 45 is configured to mate with a corresponding connector (typically one that includes a card slot). Four micro receptacles 60 are provided at the second mating end 12 and each micro receptacle 60 includes a mating face 61a and a rear face 61b. While such data rates are not required, the micro receptacles 60 mounted in the plug module 10 can each support a two-way 25 Gbps channel with a design that provides one transmit pair and one receive pair (both configured to operate at 25 Gbps using NRZ encoding) with a total of 16 pins while being less than 7 mm wide. It should be noted that the depicted plug module 10 is configured as a QSFP style plug module and thus is intended to mate with a receptacle that supports four two-way channels (e.g., with a 4× receptacle) and thus it makes sense to break out the one 4× into four 1× connectors. Do to size constraints, the micro receptacles 60 have less pins than a typical SFP connector would have but for many applications the 16 pins are sufficient. It should be noted that if the plug module was configured to engage a 2× receptacle then two 1× connectors would be sufficient from a break out standpoint and the design of the plug module could be so modified.

Each micro receptacle 60 is supported on a micro board 52 and includes a cage 62 and a latch 63. The latch 63 ensures that a mating micro plug connector 90 is securely fastened to the micro receptacle 60 and is not going to fall out do to vibration and inadvertent application of force to the micro plug connector 90. It should be noted that the depicted design includes a cable 47 (shown in truncated manner) that connects the paddle card 45 to the micro board 52. For purposes of illustration the termination of the cable 47 to the micro board 52 is omitted as such a termination is known and can be substantially the same as the termination shown on the paddle card 45. As is discussed, such a configuration is not required but it has been determination that such a configuration is desirable because it allows the micro board 52 to be offset upward compared to the paddle card 45. It turns out that offsetting the micro receptacles upward compared to the paddle card 45 is beneficial for users and it can help make it easier to package the plug module in a given system. Alternative embodiments could use flex circuitry to connect the micro receptacles 60 to the paddle card 45 and still provide the offset configuration. Other alternative embodiments that provide the optional offset configuration could include the use of a non-planar circuit board but in general a circuit board tends to be more lossy than a cable so care is needed to ensure the selected configuration is compatible with the signaling frequency and loss budget.

The micro receptacles 60 provide a micro port 65 that is defined by the cage 62 (preferably formed of a metal) that extends around a tongue 73 of a housing 70 that is formed of an insulative material. The housing 70 supports the terminals 80. In an embodiment the housing can be formed of a first wafer housing 71a and a second wafer housing 71b, where the first and second water housings 71a, 71b are each insert molded around a row of terminals such that corresponding contacts 80a are supported on a first tongue half 73a and a second tongue half 73b.

As can be appreciated, the micro receptacles 60 are configured as right-angle SMT style connectors with terminal sets 68 that each provide a row of terminals and are intended to be mounted on a pad array 54 on the micro board 52. In an embodiment the terminal sets 68 can have terminals 80 on a 0.5 mm pitch. Each of the terminals 80 includes a contact 80a, a tail 80b and a body 80c that extend therebetween. As can be appreciated, the tails 80b can be provided in two rows. Naturally, the mating micro plug connector 90 has mating terminals that are also arranged at a 0.5 mm pitch. In spite of the small size, the far end crosstalk can be more than 35 dB down and preferably can be more than 40 dB down out to 12.5 GHz signaling frequency.

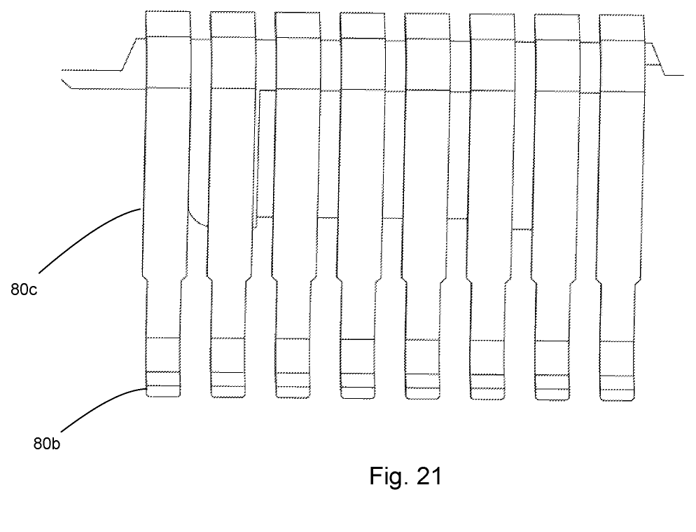

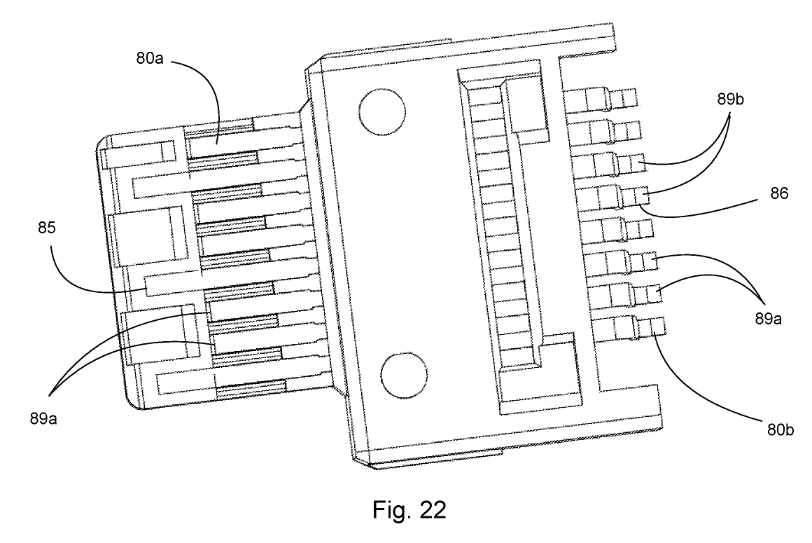

To help provide the desirable performance, one of the rows of terminals can include signal terminals 86 (that form differential signal pairs 89a, 89b) spaced apart by a ground terminal 85 and in an embodiment the tongue and contact configuration can be adjusted so that the ground terminals 85 extends past the signal terminals 86 and notches 74a, 74b are provided in the first and second tongue halves 73a, 73b where the corresponding notch is placed at the end of the signal terminals 86 that form the differential pair. While such an optional configuration is not required, it has been determined that for a compact design as depicted it is beneficial to have the notches 74a, 74b as depicted so as to improve the tuning of the terminals. The notches 74a, 74b, in combination with tuning apertures 77, can be arranged so that the signal terminals are preferentially coupled (e.g., more signal energy travels on the signal terminals than would normally travel on a symmetric configuration). This can be done by modifying the dielectric constant of the structure surrounding the signal terminals so that they are more tightly coupled together than one of the signal terminals is coupled to an adjacent ground terminal. As can be appreciated from FIG. 21, however, in an embodiment the spacing and construction of the terminals can be symmetric in that the space between ground and signal terminals, along with the shape of the terminals, is substantially the same along the body and tail sections.

As depicted, the first wafer half 71a includes a terminal block 82 that attaches to a projection 81 via a receiving channel 84. The terminal block 82, while it can be integrated into the first wafer half 71a, is preferably separate and provides a terminal comb 83 that helps control the location and spacing of the tails. The second wafer half 71b can be an integral unit, as is depicted.

One issue that exists is the inclusion of the latch 63. As can be appreciated, there is very little space available and a latch that could be operated without a tool would be difficult to package. For certain applications a latch may not be required. However, for server applications and any applications where there is a need for a robust configuration that is resistant to accidental disengagement of a connector, a latch is needed. While it is common to place the latch on the plug module, the micro plug modules are so small and the space is so tight when they are arranged as depicted that providing a latch on the micro plugs is not feasible. As a result, Applicants have determined that the latch 63 can be provided on the micro receptacle 60.

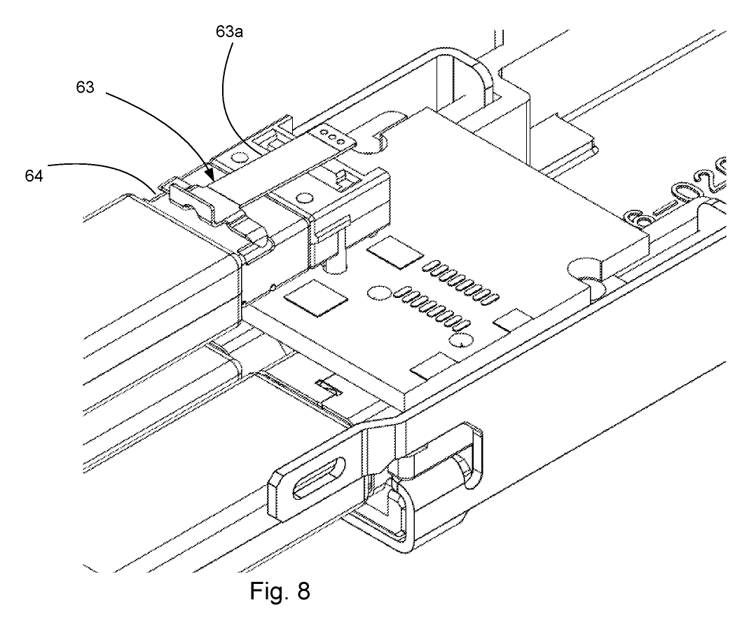

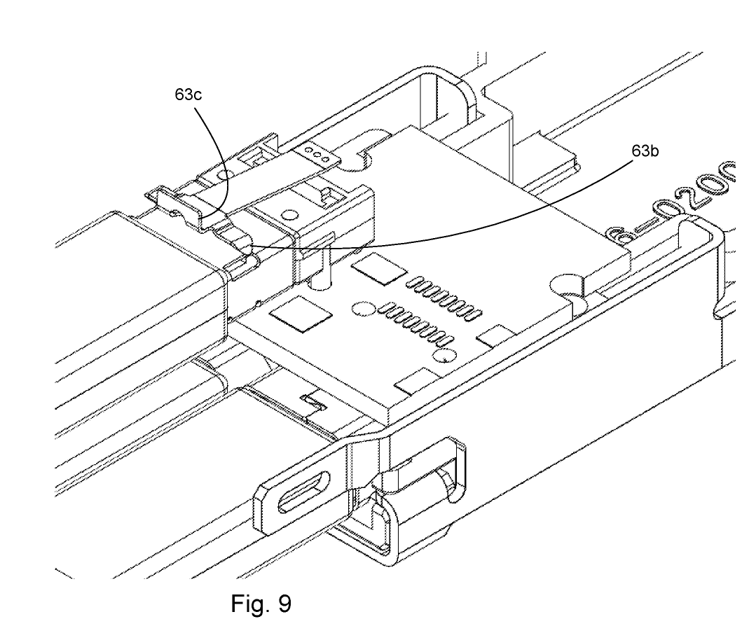

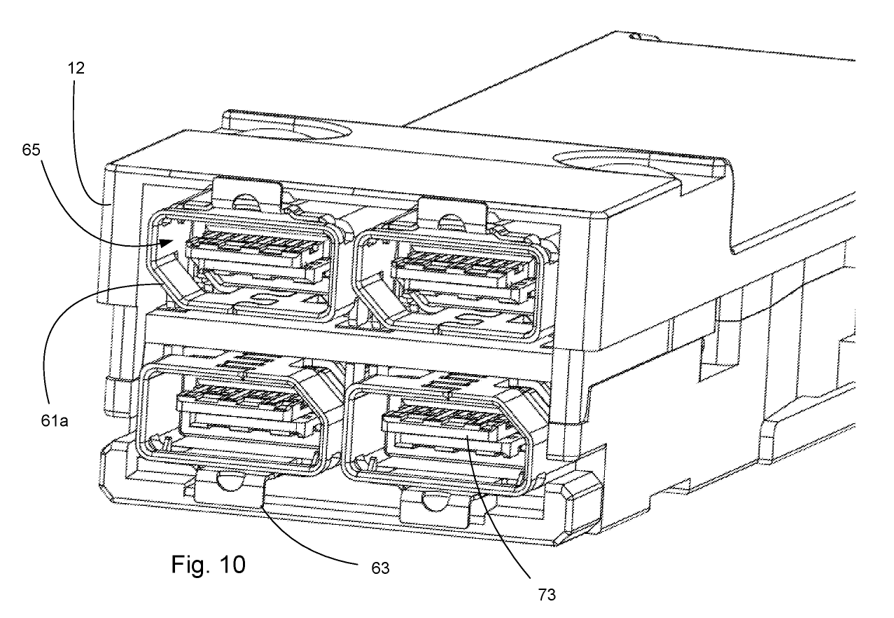

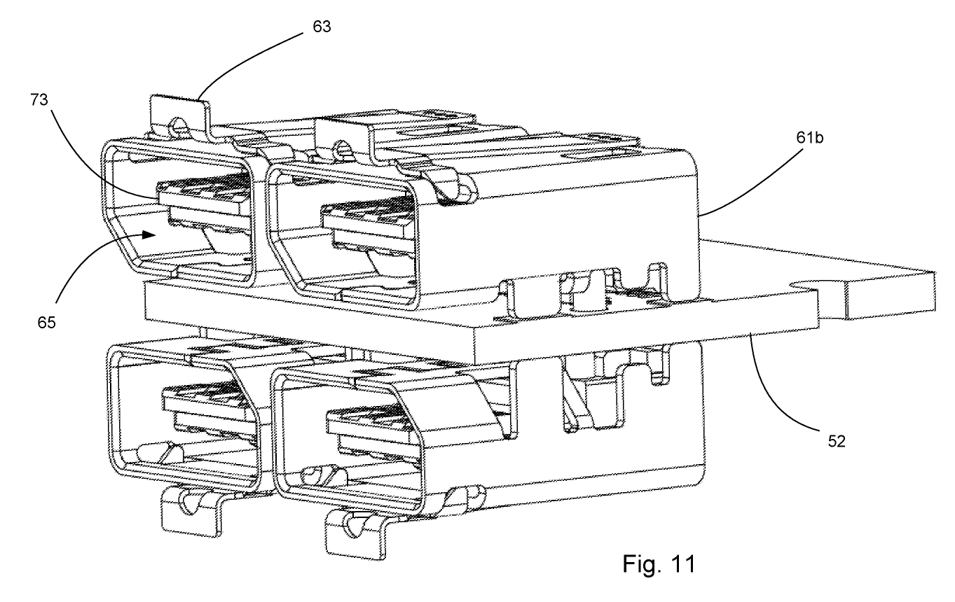

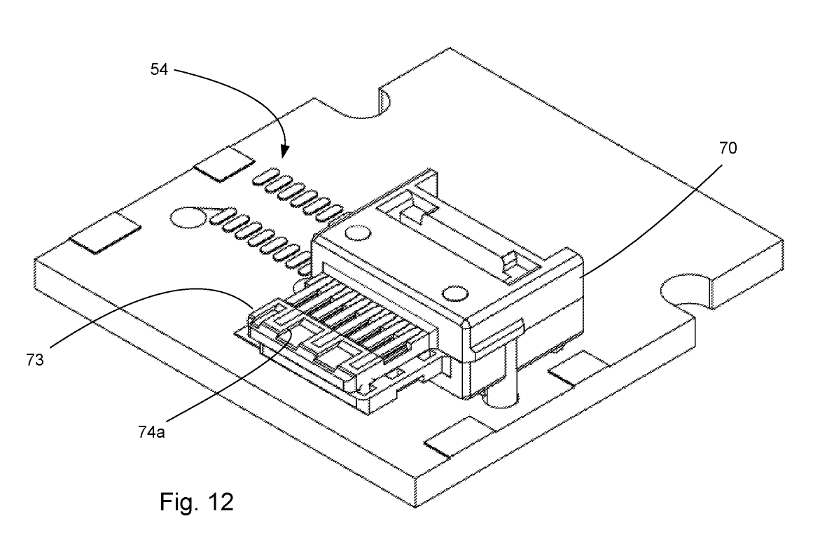

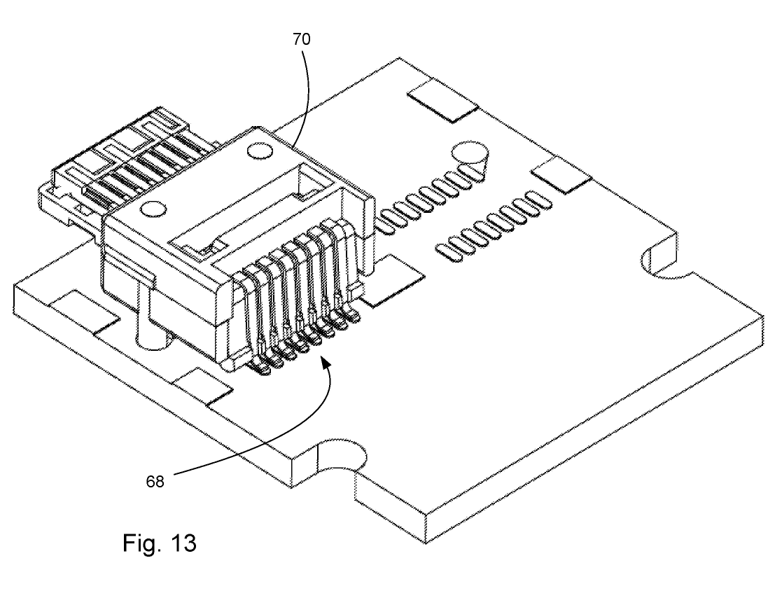

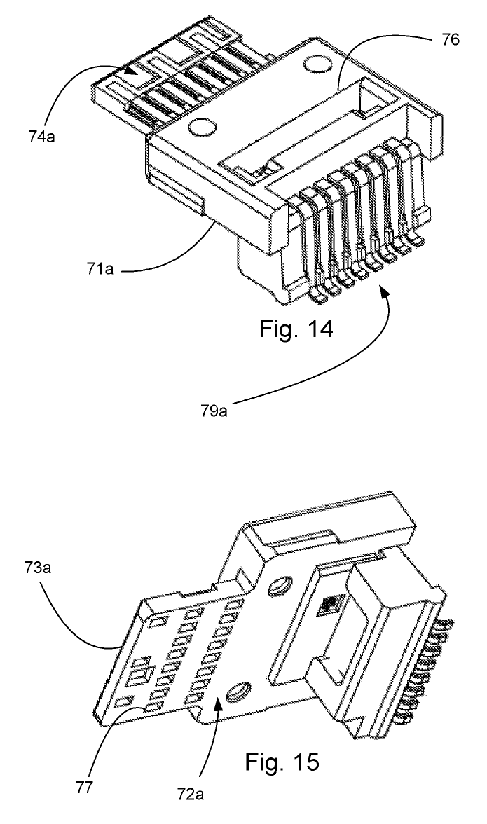

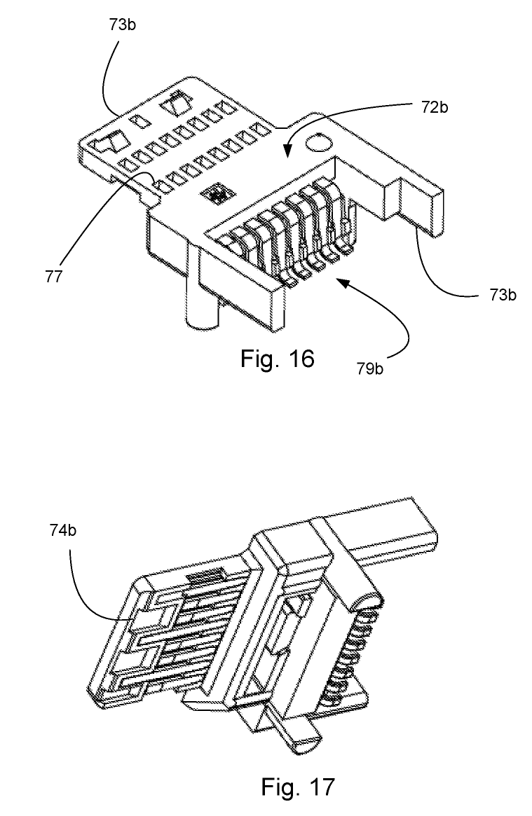

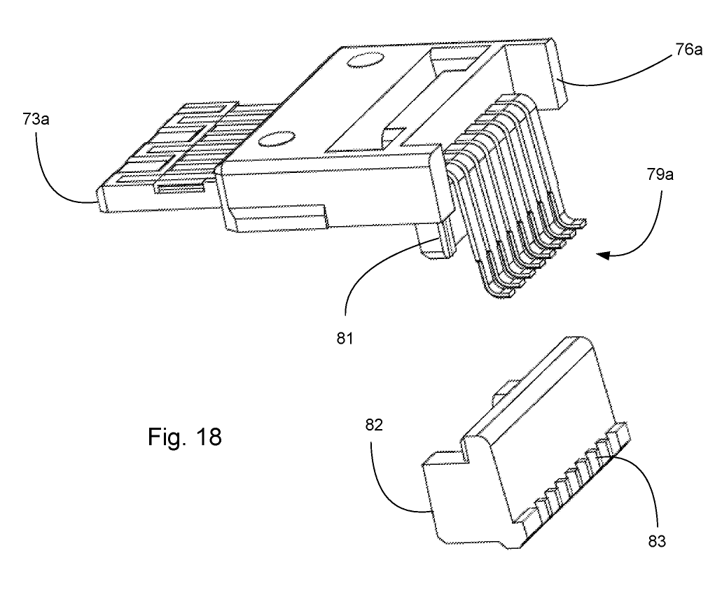

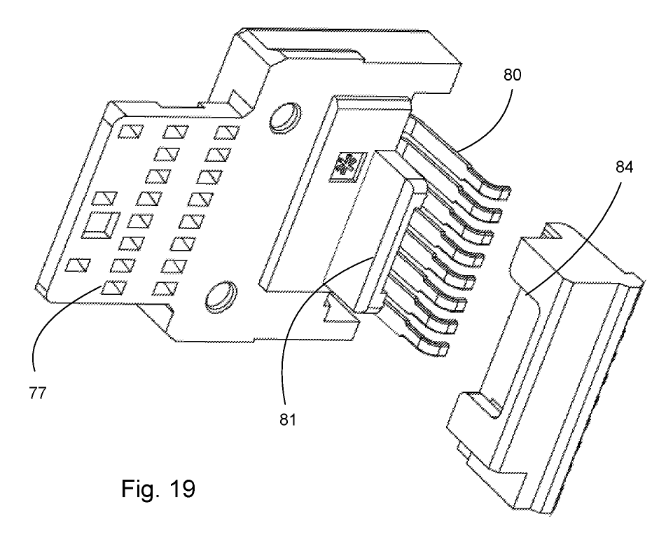

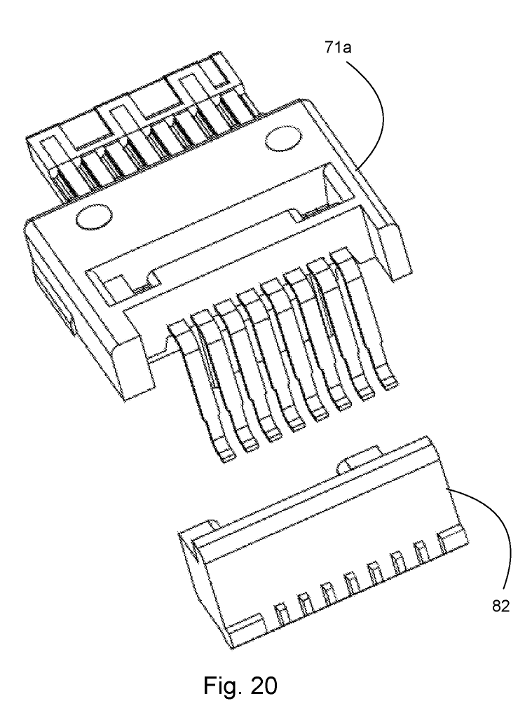

The depicted system therefore includes an optional latch 63 that is configured to retain a micro plug module that is inserted into the micro receptacle. The latch 63 includes a securing arm 63a that has one end secured to the cage 62 of the micro receptacle 60 and has retaining fingers 63b that extend through retaining apertures 64 in the cage 62 so that the retaining fingers 63b can engage the inserted plug connector and a release flange 63c is moveable with the use of a tool. In operation a tool can be inserted under the release flange 63c so as to cause the securing arm 63a to be translated upward. This will cause retaining fingers 63b on the securing arm 63a to disengage from retaining holes in the micro plug and the micro plug can then be removed. The translation of the securing arm 63a can be appreciated from the embodiments depicted in FIGS. 8 and 9. Naturally, if it is desirable to remove several micro plugs from a plug module 10 then it may be easier to first disconnect the plug module first and then remove the micro plugs.

As noted above, the micro receptacles 60 are mounted on a micro board 52. As depicted, the micro board 52 is separate from the paddle card 45. In an alternative embodiment the paddle card could be extended so that the micro board 52 and the paddle card 45 were integral or a single board and the micro receptacles 60 could be mounted directly on the paddle card 45 (and thus communicate via traces provided on the paddle card 45). Otherwise the micro board 52 and the paddle card 45 can be connected together in any desirable manner. It should be noted that if desired the plug module could also include circuitry such as a retimer and/or an amplifier to allow for improved operation.

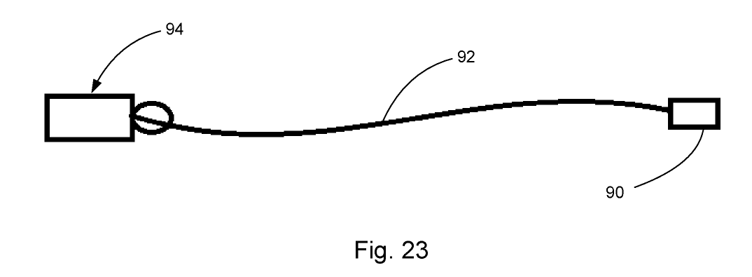

While active components can be added, it should be noted that the depicted configuration is intended to work as a passive system in certain applications. This is beneficial because the micro plug modules can be mounted on a cable assembly that has a different style connector on the opposite end. Thus the micro plug connector 90 could be provided on one end of a cable 92 and a conventional SFP style plug 94 could be placed on the other end (such as is depicted schematically in FIG. 23).

The disclosure provided herein describes features in terms of preferred and exemplary embodiments thereof Numerous other embodiments, modifications and variations within the scope and spirit of the appended claims will occur to persons of ordinary skill in the art from a review of this disclosure.

What is claimed is:

1. A plug module, comprising:
a body with a first mating end and a second mating end, the first end configured to be inserted into a predefined port;
a paddle card positioned in the first end and including a plurality of contact pads, the paddle card configured to receive at least two transmit channels and two receive channels; and
a first micro receptacle and a second micro receptacle supported at the second mating end, wherein the first and second micro receptacle are each configured to include one of the two transmit channels and one of the two receive channels.

2. The plug module of claim 1, further comprising a micro board that supports the first and second micro receptacles, the micro board offset upward compared to the paddle card.

3. The module of claim 2, wherein at least one cable connects the micro board to the paddle card.

4. The module of claim 2, wherein the micro receptacles are positioned on two sides of the micro board.

5. The module of claim 1, wherein each micro receptacle has at least 16 pins arranged on a 0.5 mm pitch.

6. The module of claim 1, wherein each micro receptacle includes an individual latch, each latch configured, in operation, to releasably engage a mating micro plug module.

7. A plug module system, comprising:
a plug module as defined in claim 6; and
a cable assembly mated to the plug module, the cable assembly including a micro plug connector with terminals at a 0.5 mm pitch, wherein the micro receptacle and the micro plug connector are configured to support 12.5 GHz signaling over a transmit channel and a receive channel with less than 35 dB far end crosstalk.

8. The module system of claim 7, wherein the cable assembly has an SFP connector mounted on the other end.

9. The module system of claim 7, wherein a plurality of cable assemblies are mounted to the plug module, wherein one of the plurality of cable assemblies has a first length and another of the plurality of cables assembles has a second length, the first length being different than the second length.
